(19) United States
(12) Patent Application Publication
(10) Pub. No.: US 2005/0216339 A1
(43) Pub. Date: Sep. 29, 2005

(54) Systems and methods for optimizing advertising

(76) Inventors: Robert Brazell, Salt Lake City, UT (US); Robert H. Powell, Idaho Falls, ID (US); Robert Wolf, Sandy, UT (US)

Correspondence Address: KIRTON & McCONKIE;Suite 1800, 60 East South Temple, Salt Lake City, UT, 84111, US

(21) Appl. No.: 11/047,251

(22) Filed: Jan. 31, 2005

Related U.S. Application Data
(63) Continuation-in-part of application No. 10/983,789, filed on Nov. 8, 2004.
Application No. 10/983,789 is a continuation-in-part of application No. 10/822,545, filed on Apr. 12, 2004.
(60) Provisional application No. 60/541,542, filed on Feb. 3, 2004.

(51) Int. Cl. G06F 17/60

(52) U.S. Cl. 705/14

(57) ABSTRACT

The present invention relates to methods of measuring customer response and methods of optimizing advertising in response to the customer response data. One embodiment of the present invention relates to a method of acquiring data about the advertising preferences of particular groups of customers. For example, this data may include analyzing the shopping response of all married female shoppers over 40 years of age after a particular advertisement is played; this shopping response could then be compared with the shopping response of a similar group after a different advertisement is played. Another embodiment of the present invention relates to optimizing advertising variable settings with respect to acquired advertising data in an effort to identify optimized advertising variable settings for identifiable groups of customers. Yet another embodiment of the present invention relates to a method of generating an advertisement with optimized advertisement variable settings for an advertising target group. For example, if data indicates that a particular demographic responds to a male advertiser, the advertisement will be spoken with a male voice and played during that time period. Yet another embodiment of the present invention relates to measuring customer response data of various message media and combinations of message media.

### RELATED APPLICATIONS

This is a continuation-in-part application of U.S. application Ser. No. 10/983,789, filed Nov. 8, 2004, which is a continuation-in-part application of U.S. application Ser. No. 10/822,545, filed Apr. 12, 2004 which claims priority to U.S. provisional application Ser. No. 60/541,542, filed Feb. 3, 2004.

### BACKGROUND

1. Field of the Invention

The present invention relates to a method of optimizing advertising. More particularly, the present invention relates to methods of acquiring advertising data and methods of optimizing advertising variable settings in response to acquired data.

2. Background

Advertising is the process through which companies attempt to convince customers to purchase their products. Advertising takes many forms including radio advertisements, in-store audio advertisements, television advertisements, billboards, etc. The production and broadcasting of these advertisements has become more and more expensive. Companies wish to maximize the effect of their advertisements by determining the most effective message to promote. Numerous marketing textbooks and classes discuss this field.

In order to sell advertising to companies, particular information must often be provided which illustrates the effects of the advertising. The advertising industry standard for analyzing the effectiveness of an advertisement is the metric values of reach and frequency with which the advertisement is received by customers. The reach is the percentage of customers who are exposed to the advertisement and the frequency is the number of times an individual customer is exposed to the same advertisement. Companies generally wish to maximize their reach for a certain maximum frequency. This value is generally expressed in the form of a RF curve of reach versus rating points, wherein each rating point has an associated price value. Unfortunately, these metric values are rarely analyzed for in-store advertising because of the availability of sales information.

One of the major obstacles in creating effective advertising is determining a customer's response to a particular advertisement. Traditionally companies have used focus groups and surveys in order to obtain customer response information about their products and/or advertisements. This customer response information can then be used to adjust or manipulate their advertisements. Unfortunately, these techniques of generating customer response information have been found to be inadequate and often inaccurate. Therefore, there is a need for a new method of generating customer response information that is both efficient and reliable.

Another problem with maximizing the effectiveness of advertising is the significant time delay between obtaining the customer response data, creating the advertisement, and broadcasting the advertisement. In many circumstances, the initial data indicating what will be effective in advertising a particular product may expire or become inaccurate. Therefore, there is also a need for a process that is able to efficiently generate an advertisement with respect to time sensitive customer response data.

Yet another problem with maximizing the effectiveness of advertising is the need to identify the most appropriate target audience. Some products are purchased by a wide variety of customers such as toilet paper and toothpaste while others are purchased by only a particular group. A significant loss in advertising effectiveness results if a wide-use product is only advertised to a select group of customers. Therefore, there is a need in the industry for a process of identifying a target group for a particular product, which can then be used to maximize the efficiency of a particular advertisement directed at selling the product.

### SUMMARY

The present invention relates to methods of measuring customer response and methods of optimizing advertising in response to the customer response data. One embodiment of the present invention relates to a method of acquiring data about the advertising preferences of particular groups of customers. For example, this data may include analyzing the shopping response of all married female shoppers over 40 years of age after a particular advertisement is played; this shopping response could then be compared with the shopping response of a similar group after a different advertisement is played. Another embodiment of the present invention relates to optimizing advertising variable settings with respect to acquired advertising data in an effort to identify optimized advertising variable settings for identifiable groups of customers. Yet another embodiment of the present invention relates to a method of generating an advertisement with optimized advertisement variable settings for an advertising target group. For example, if data indicates that a particular demographic responds to a male advertiser, the advertisement will be spoken with a male voice and played during that time period. Yet another embodiment of the present invention relates to measuring customer response data of various message media and combinations of message media.

This technology provides numerous advantages over the prior art including arbitrary audience targeting and near real time measurement and adjustment. Arbitrary audience targeting allows for advertisements to be tailored to specifically target a particular group of customers. Real time measurement includes identifying the customer response to a particular advertisement.

These and other features and advantages of the present invention will be set forth or will become more fully apparent in the description that follows and in the appended claims. The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE DRAWINGS

In order that the manner in which the above-recited and other advantages and features of the invention are obtained, a more particular description of the invention briefly described above will be rendered by reference to specific embodiments thereof which are illustrated in the appended drawings. Understanding that these drawings depict only typical embodiments of the invention and are not therefore to be considered limiting of its scope, the invention will be described and explained with additional specificity and detail through the use of the accompanying drawings in which:

FIG. 1 illustrates a representative system that provides a suitable operating environment for use of the present invention;

FIG. 2 is a flow chart illustrating one embodiment of a method for optimizing an advertisement in response to customer data;

FIG. 3 is a flow chart illustrating one embodiment of a method for acquiring customer response data including optimum advertising variable settings for a plurality of advertising groups;

FIG. 4 is a flow chart illustrating one embodiment of a method for broadcasting a plurality of test advertisements with unique sets of advertisement variable settings;

FIG. 5 is a flow chart illustrating one embodiment of a method for generating an advertisement with optimized advertising variable settings for an advertising target group;

FIG. 6 is a flow chart illustrating one embodiment of a method for automatically broadcasting an efficient advertisement with respect to present customers;

FIG. 7 is a chart illustrating various customer response metric measurements in response to a particular media; and

FIG. 8 is a group of charts which each illustrate RF curves of customer response to a particular media.

### DETAILED DESCRIPTION OF THE PREFERRED EMBODIMENTS

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

The present invention relates to methods of measuring customer response and methods of optimizing advertising in response to the customer response data. One embodiment of the present invention relates to a method of acquiring data about the advertising preferences of particular groups of customers. For example, this data may include analyzing the shopping response of all married female shoppers over 40 years of age after a particular advertisement is played; this shopping response could then be compared with the shopping response of a similar group after a different advertisement is played. Another embodiment of the present invention relates to optimizing advertising variable settings with respect to acquired advertising data in an effort to identify optimized advertising variable settings for identifiable groups of customers. Yet another embodiment of the present invention relates to a method of generating an advertisement with optimized advertisement variable settings for an advertising target group. For example, if data indicates that a particular demographic responds to a male advertiser, the advertisement will be spoken with a male voice and played during that time period. Yet another embodiment of the present invention relates to measuring customer response data of various message media and combinations of message media. While embodiment of the present invention are directed at methods of acquiring advertising data and optimizing advertisements, it will be appreciated that the teachings of the present invention are applicable to other areas.

As used in this specification, the following terms are defined accordingly:

“advertisement” includes all forms of advertising; including but not limited to audio, video, still visual, touch, taste, smell, and any combination thereof.

“optimized advertisement” is an advertisement that is specifically optimized for an advertising target group.

“customer response data” includes identifying various customer reactions to an advertisement with respect to advertising variable settings included in the advertisement. These reactions include but are not limited to purchasing a product, not purchasing a product, changing routine, and leaving the store. Therefore, complete customer response data will include correlating various customer reactions with customer information and advertising variable settings.

“advertising variable settings” include the settings of various variables that affect how an advertisement is perceived. These variables include but are not limited to frequency, duration, play time, volume, gender of speaker(s)/actor(s), sound/video icons, smell icons, taste icons, background music/scenery, sound effects, special effects, presence/absence of pricing information, variations in pricing, variations in offer, value added content, seasonal related message, category promotions, variations on the product message, and promotional offers.

“optimized advertising variable settings” is a set of advertising variable settings that are optimized for a particular advertising target group.

“advertising group” is a group of people who share at least one characteristic or trait.

“advertising target group” is a group of people who share at least one characteristic and who are targeted for a particular advertisement. For example, males over 50 years old may be an advertising target group for a luxury automobile.

“test advertisement” is an advertisement or message that is played for a purpose including but not limited to obtaining customer response data.

“customer response device” is a device that measures a customers response. For example, a loyalty/membership card, a point-of-sale device, a credit-card related device, an RFID, a survey response device, etc.

“customer information device” is a device that transfers information about a customer. A customer information device may or may not be the same as a customer response device. For example, a customer loyalty card includes customer information but an RFID located on a particular product does not contain any customer information.

“advertisement components” are various components of an advertisement that can be used independently or compiled with other components to create a complete advertisement. For example, various prices may be recorded for an audio advertisement and then compiled with other information into complete advertisements as the price of a particular item is lowered.

“optimization algorithm” is a procedure that is used to obtain the most efficient variable setting for a unique input. For example, if a store has 2 women, 8 men, and 4 children, an optimization algorithm could utilize known data to determine what is the most efficient set of advertising variable settings for that particular scenario. Likewise, an optimization algorithm can be used to determine the optimum advertising variable settings for a particular advertising group in relation to a set of customer response data.

“metric” is a standard customer response measurement including but not limited to reach, frequency, sales, awareness, etc.

“media” is the vehicle through which an advertisement or message is broadcast to customers. Media includes but is not limited to audio, video, shopping cart, billboard, television, radio, internet, smell, touch, taste, in-store media, out-of-store media, and any combination thereof.

The following disclosure of the present invention is grouped into three subheadings, namely “Exemplary Operating Environment”, “Advertisement Optimization”, and “Measuring Customer Response.” The utilization of the subheadings is for convenience of the reader only and is not to be construed as limiting in any sense.

### Exemplary Operating Environment

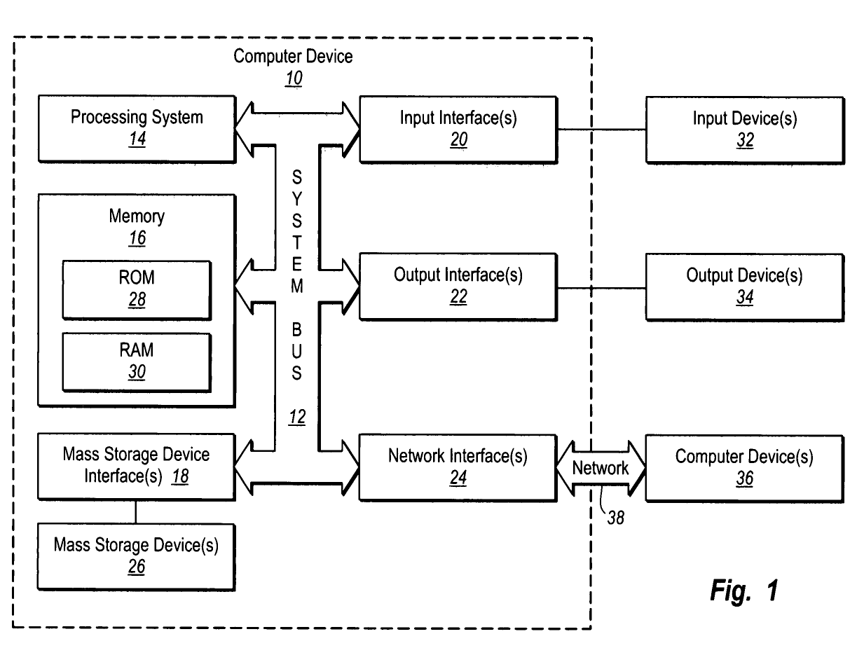

FIG. 1 and the corresponding discussion are intended to provide a general description of a suitable operating environment in which the invention may be implemented. One skilled in the art will appreciate that the invention may be practiced by one or more computing devices and in a variety of system configurations, including in a networked configuration. Alternatively, the invention may also be practiced in whole or in part manually following the same procedures.

Embodiments of the present invention embrace one or more computer readable media, wherein each medium may be configured to include or includes thereon data or computer executable instructions for manipulating data. The computer executable instructions include data structures, objects, programs, routines, or other program modules that may be accessed by a processing system, such as one associated with a general-purpose computer capable of performing various different functions or one associated with a special-purpose computer capable of performing a limited number of functions. Computer executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), or any other device or component that is capable of providing data or executable instructions that may be accessed by a processing system.

With reference to FIG. 1, a representative system for implementing the invention includes computer device 10, which may be a general-purpose or special-purpose computer. For example, computer device 10 may be a personal computer, a notebook computer, a personal digital assistant (“PDA”) or other hand-held device, a workstation, a minicomputer, a mainframe, a supercomputer, a multi-processor system, a network computer, a processor-based consumer electronic device, or the like.

Computer device 10 includes system bus 12, which may be configured to connect various components thereof and enables data to be exchanged between two or more components. System bus 12 may include one of a variety of bus structures including a memory bus or memory controller, a peripheral bus, or a local bus that uses any of a variety of bus architectures. Typical components connected by system bus 12 include processing system 14 and memory 16. Other components may include one or more mass storage device interfaces 18, input interfaces 20, output interfaces 22, and/or network interfaces 24, each of which will be discussed below.

Processing system 14 includes one or more processors, such as a central processor and optionally one or more other processors designed to perform a particular function or task. It is typically processing system 14 that executes the instructions provided on computer readable media, such as on memory 16, a magnetic hard disk, a removable magnetic disk, a magnetic cassette, an optical disk, or from a communication connection, which may also be viewed as a computer readable medium.

Memory 16 includes one or more computer readable media that may be configured to include or includes thereon data or instructions for manipulating data, and may be accessed by processing system 14 through system bus 12. Memory 16 may include, for example, ROM 28, used to permanently store information, and/or RAM 30, used to temporarily store information. ROM 28 may include a basic input/output system (“BIOS”) having one or more routines that are used to establish communication, such as during start-up of computer device 10. RAM 30 may include one or more program modules, such as one or more operating systems, application programs, and/or program data.

One or more mass storage device interfaces 18 may be used to connect one or more mass storage devices 26 to system bus 12. The mass storage devices 26 may be incorporated into or may be peripheral to computer device 10 and allow computer device 10 to retain large amounts of data. Optionally, one or more of the mass storage devices 26 may be removable from computer device 10. Examples of mass storage devices include hard disk drives, magnetic disk drives, tape drives and optical disk drives. A mass storage device 26 may read from and/or write to a magnetic hard disk, a removable 10 magnetic disk, a magnetic cassette, an optical disk, or another computer readable medium. Mass storage devices 26 and their corresponding computer readable media provide nonvolatile storage of data and/or executable instructions that may include one or more program modules such as an operating system, one or more application programs, other program modules, or program data. Such executable instructions are examples of program code means for implementing steps for methods disclosed herein.

One or more input interfaces 20 may be employed to enable a user to enter data and/or instructions to computer device 10 through one or more corresponding input devices 32. Examples of such input devices include a keyboard and alternate input devices, such as a mouse, trackball, light pen, stylus, or other pointing device, a microphone, a joystick, a game pad, a satellite dish, a scanner, a camcorder, a digital camera, and the like. Similarly, examples of input interfaces 20 that may be used to connect the input devices 32 to the system bus 12 include a serial port, a parallel port, a game port, a universal serial bus (“USB”), a firewire (IEEE 1394), or another interface.

One or more output interfaces 22 may be employed to connect one or more corresponding output devices 34 to system bus 12. Examples of output devices include a monitor or display screen, a speaker, a printer, and the like. A particular output device 34 may be integrated with or peripheral to computer device 10. Examples of output interfaces include a video adapter, an audio adapter, a parallel port, and the like.

One or more network interfaces 24 enable computer device 10 to exchange information with one or more other local or remote computer devices, illustrated as computer devices 36, via a network 38 that may include hardwired and/or wireless links. Examples of network interfaces include a network adapter for connection to a local area network (“LAN”) or a modem, wireless link, or other adapter for connection to a wide area network (“WAN”), such as the Internet. The network interface 24 may be incorporated with or peripheral to computer device 10. In a networked system, accessible program modules or portions thereof may be stored in a remote memory storage device. Furthermore, in a networked system computer device 10 may participate in a distributed computing environment, where functions or tasks are performed by a plurality of networked computer devices.

### Advertisement Optimization

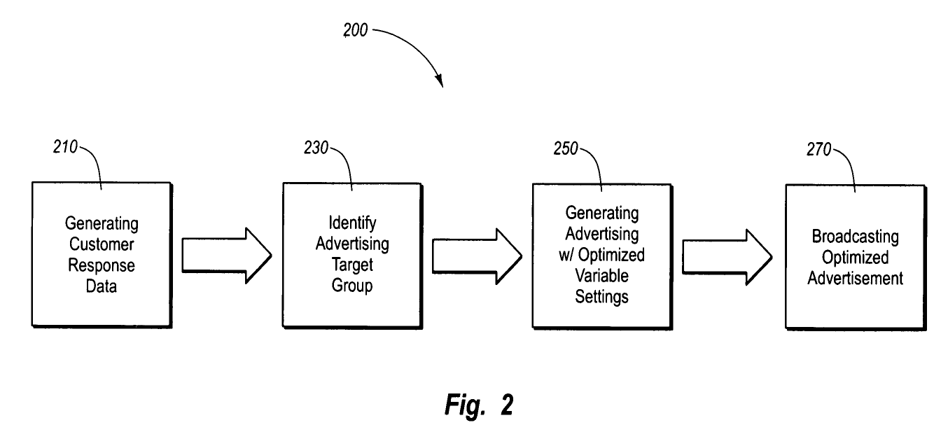

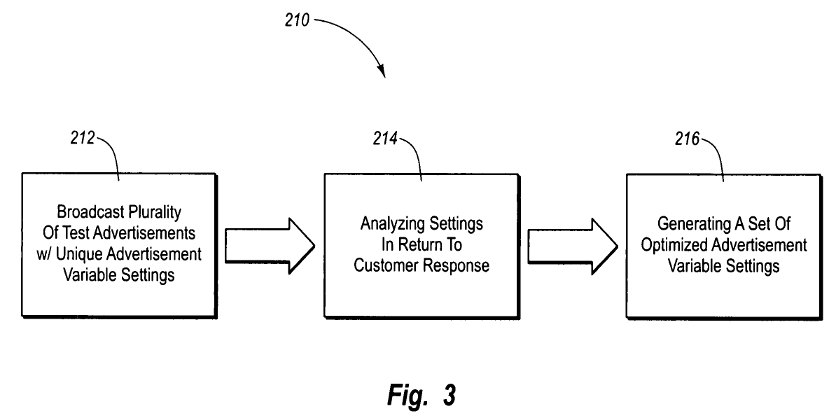

Reference is next made to FIG. 2, which is a flow chart illustrating one embodiment of a method for optimizing an advertisement in response to customer data, designated generally at 200. Although acts are shown and described in a sequential order, the steps can be performed in any order in relation to one another. The method 200 begins by generating customer response data, step 210. Customer response data includes identifying various customer reactions to an advertisement with respect to advertising variable settings included in the advertisement. Advertising variable settings include a plurality of aspects of an advertisement that can be used to identify particular customer preferences. These reactions include but are not limited to purchasing a product, not purchasing a product, changing routine, and leaving the store. Therefore, complete customer response data will include correlating various customer reactions with customer information and advertising variable settings. One embodiment of generating customer response data will be described in more detail with respect to FIG. 3. In one embodiment the step of generating customer response data 210 will include generating a set of optimum advertising variable settings for a plurality of advertising groups. The determination of optimum advertising variable settings can be accomplished with any one of a variety of optimization algorithms known to those skilled in the art.

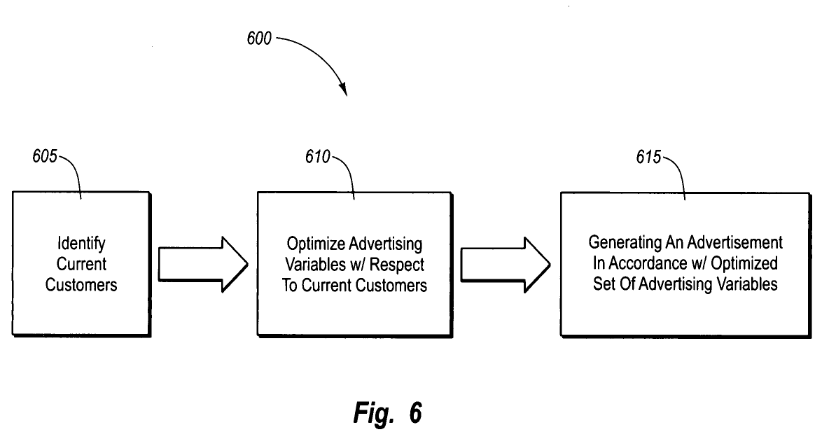

After a sufficient amount of customer response data has been obtained or generated, an advertising target group must be identified, step 230. An advertising target group is a group of individuals who have at least one trait or characteristic in common and who are targeted for a particular advertisement. For example, males over 50 years old may be an advertising target group. The advertising target group can be identified manually by determining the optimum target audience of a particular advertisement or could be determined automatically based on current customer population of a store at a particular time. For example, the manufacturer of aftershave may target males between the ages of 18 and 60. Alternatively, a manufacturer of toilet paper may wish the advertisement be automatically targeted to the current population of customers in the store. Various techniques and technology could be used for automatically identifying the current customer population at a particular store. For example, stores may require customers to scan their loyalty cards when they enter the store in order to obtain a cart. The customer loyalty card could then be used to provide customer information about the customer to a computer that maintains a constant tally of the demographics of the current customers. A method of automatically identifying current customers and manipulating advertisements accordingly is also discussed with respect to FIG. 6.

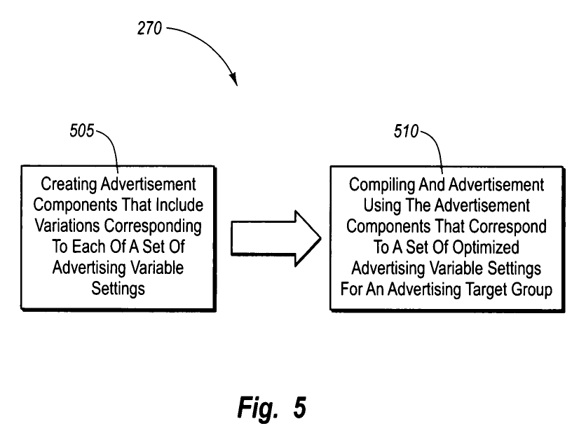

Once the advertising target group is identified, an advertisement is generated with optimized advertising variable settings, step 250. Therefore, if one of the optimized advertising variable settings for the target advertising group is a male speaker in an audio advertisement, the advertisement will be generated with a male speaker. The generated advertisement may include one or flexible advertising variable settings depending on the objectives of the advertising company. Some advertising variable settings are almost always flexible such as volume and frequency. However, other advertising variable settings require that the producer of the advertisement add additional content to allow for flexibility such as price quotes, gender of speaker, seasonal greetings, etc. This additional content is known as advertising components. In this respect, an advertisement may be recorded with two different voices that may appeal to two different advertising target groups. In addition, if the step of generating customer data 210 did not include providing a list of optimized variable settings for all advertising groups, the producer of the advertisement may need to analyze the customer data manually and select the desired format of the advertisement. Alternatively, portions of the step of generating an advertisement with optimized variable settings 250 may be performed automatically by a computer as discussed with respect to FIGS. 5 and 6.

Once the optimized advertisement is generated, the optimized advertisement is broadcast, step 270. Broadcasting the advertisement includes all forms of exposing the public to the advertisement including hanging a poster, playing an audio track, playing a video track, distributing a smell, or any combination thereof. Since the time of day and the location of an advertisement are important advertising variable settings, the broadcasting of the advertisement will also need to be consistent with the optimized set of variables. Likewise, the advertisement may also be broadcast at additional non-optimized times or locations as a test advertisement for obtaining more customer response data.

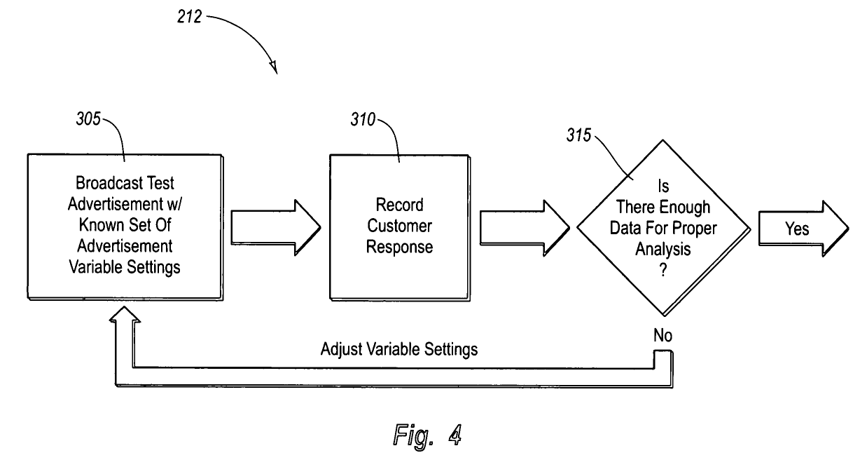

Reference is next made to FIG. 3, which is a flow chart illustrating one embodiment of a method for acquiring customer response data including optimum advertising variable settings for a plurality of advertising groups. The method is designated generally at 210 corresponding to the similar step in FIG. 2. The method 210 may be performed independently or as part of the method described with respect to FIG. 2. Initially, a plurality of test advertisements are broadcast with unique advertising variable settings, step 212. Test advertisements are actual advertisements that are broadcast with known advertisement variable settings. Each of the plurality of broadcast test advertisements has unique advertisement variable settings. One embodiment of broadcasting a plurality of test advertisements is described in more detail with reference to FIG. 4. The step of broadcasting a plurality of test advertisements includes recording customer response data that can be correlated with each of the test advertisements.

Once the plurality of test advertisements are broadcasted, the advertising variable settings of each of the test advertisements are analyzed in relation to the corresponding customer response data, step 214. It is desirable to attempt to correlate which advertising variable settings affect which customer groups by identifying which test advertisements cause customers to respond in positive ways. Naturally, some customer groups will overlap with one another and certain advertising variable settings may affect customer groups in different ways. This analysis can be performed manually, automatically, or some combination thereof. Various automatic computer algorithms could be used which are known to those skilled in the art.

Once the analysis is complete, a set of optimized advertisement variables is created for a particular advertising target group, step 216. The set of optimized advertising variable settings may or may not be a complete set of advertising variable settings. For example, women under 18 may prefer a female voice, at high volume, repeated frequently, a rose smell, and with lots of sound effects. This set of optimized advertising variable settings is not a complete set of advertising variable settings and will allow the remaining variables to be set at random or set for another purpose.

Reference is next made to FIG. 4, which is a flow chart illustrating one embodiment of a method for broadcasting a plurality of test advertisements with unique sets of advertisement variable settings. The method is designated generally at 212 corresponding to the similar step in FIG. 3. This method may be performed independently or as part of the method described with respect to FIG. 3. Initially, a single test advertisement is broadcast with a known set of advertisement variable settings, step 305. As discussed above, the term “broadcast” is used broadly to describe any manner in which an advertisement may be exposed to the public. Numerous different advertisement variables may or may not be present in the broadcast test advertisement. For example, a video advertisement may also include a smell that is simultaneously dispensed from a plurality of sprayers. Likewise, an audio advertisement may include various sound effects. Customer's corresponding responses are then recorded, step 310. A query is then performed to determine whether enough customer response data has been accumulated for proper analysis, step 315. At least two test advertisements must be broadcast in order to perform any analysis. The analysis included comparing the at least two test advertisements to one another to generate information. The determination of how many test advertisements is enough for proper analysis can be determined manually or automatically. If there is sufficient customer response data, the method will proceed to whatever next step or method is provided. If there is not sufficient customer response data for analysis, the advertisement variables will be adjusted and the step of broadcasting a test advertisement will be repeated, as shown. It should also be noted that any broadcast of an advertisement may be considered the broadcast of a test advertisement for the purpose of gathering additional customer response data. Therefore, this method 212 may be implemented continually through the process of advertising.

Reference is next made to FIG. 5, which is a flow chart illustrating one embodiment of a method for generating an advertisement with optimized advertising variable settings for an advertising target group. The method is designated generally at 270 corresponding to the similar step in FIG. 2. The method 270 may be performed independently or as part of the method described with reference to FIG. 2. Initially, various advertising components are created, step 505. Advertising components are portions of an advertisement that can be used independently as an advertisement or must be coupled with additional components to form a complete advertisement. The advertising components correspond to advertising variable settings. For example, one component might be an audio advertisement recorded with a female voice while another might be the same advertisement recorded with a male voice. Alternatively, a sound effect may be recorded as a separate advertising component which may or may not be compiled into a complete advertisement. Certain advertising variable settings do not require additional advertising components to be generated in order to allow for their adjustment. For example, the volume of an audio advertisement can be adjusted in accordance with optimized settings without the need to record additional advertising components. It is not necessary to provide advertising components corresponding to all of the advertising variable settings, only the advertising variable settings which the advertisement producer wishes to be flexible.

Once all the necessary advertising components are created, the complete advertisement is compiled utilizing components that correspond to a set of optimized advertising variable settings, step 510. This step may be performed manually or automatically depending on the application. For example, if an advertiser only wants to optimally target a single customer group in one particular location, a single version of the advertisement may be manually compiled and transferred to the location. However, if the advertiser wishes the advertisement to be part of a dynamic advertising system, the advertisement may be compiled automatically by a computer in response to a particular situation. A dynamic advertising system is described in more detail with reference to FIG. 6.

Reference is next made to FIG. 6, which is a flow chart illustrating one embodiment of a method for automatically broadcasting an efficient advertisement with respect to present customers. The method is designated generally at 600 and may be performed independently or as part of another method. Initially, a current set of customers is identified, step 605. The identity and characteristics of current customers is obtained through one or more techniques and/or technologies. For example, loyalty card scanning, video face recognition, manual input, etc. Numerous technologies are becoming available that allow retailers to obtain customer information and customer response data. These technologies are known to those skilled in the art and the use of any such technology is consistent with the teachings of the present invention.

Once information is obtained about current customers, a set of optimized advertising variable settings can be dynamically determined that will maximize the affect of an advertisement, step 610. The optimized advertising variable settings may be the optimal variable settings for the most prevalent customer group in the store or they may be a custom set of advertising variable settings that is a statistically generated to maximize the affects of an advertisement. Various other techniques may also be used to determine the optimized advertisement variable settings.

After the optimized advertising variable settings are established, an advertisement is generated in accordance with the optimized advertising variable settings, step 615. The advertisement is dynamically generated in order to capitalize on the narrow time frame in which the advertising variable settings are optimized. The advertisement is compiled using advertisement components that are previously created in order to allow for flexibility in various advertising variable settings.

### Measuring Customer Response

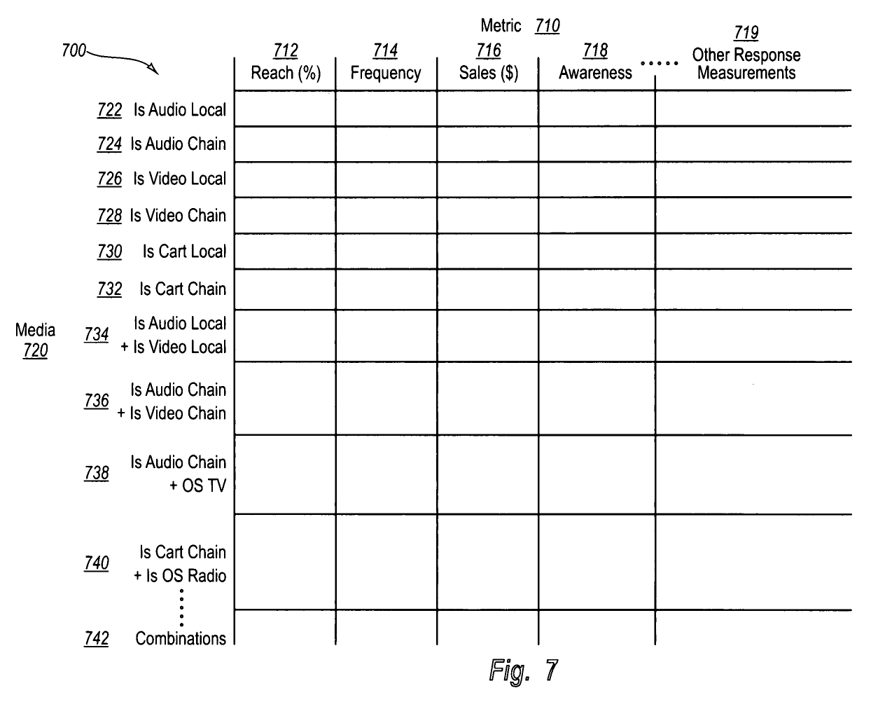

Reference is next made to FIG. 7, which illustrates a chart showing various customer response metric measurements in response to a particular media. The chart is designated generally at 700. As described above, customer response data can be used to optimize advertising. In addition, it can be used to provide advertisers with information such that they can decide how much money to spend on advertising in various forms of media. Most advertisers utilize metric values to determine which forms of media to advertise their product in. For example, $1000 on network television may only reach 5% of the population whereas $1000 on the radio may reach 12% of the population. Reach is one form of metric value used to analyze the effectiveness of an advertisement or message. FIG. 7 shows a chart of metric values 710 versus media 720. The metric values 710 include reach 712, frequency 714, sales 716, awareness 718, and other response measurements 719. Likewise, the media 720 include In-Store (IS) audio local 722, IS audio chain 724, IS video local 726, IS video chain 728, IS cart local 730, IS cart chain 732, IS audio local+IS video local 734, IS audio chain+OS TV 738, IS cart chain 740+OS radio 740, and combinations 742.

The metric values each contain a different type of information about how a particular media affects customers. Reach 712 is a percentage value of customers who received the message via the corresponding media 720. Frequency 714 is the number of times a customer received the message via the corresponding media 720. Sales 714 are the revenue generated from customers in response to the corresponding media 720. Awareness includes the percentage of customers who are aware of the product as a result of the media 720. Likewise, any similar measurement or combination of measurements may be considered a metric 710 for purposes of this application.

Metric values are not necessarily directly measured but can be extrapolated from other information with a variety of techniques. For example, in a store environment customer response devices enable the recordation of various customer responses after an advertisement or message is broadcast. These responses include purchasing products, altering a standard shopping path, leaving the store, etc. Various customer response devices and customer response data processes may be used to determine metric values and remain consistent with the present invention.

The media 720 are various channels over which to convey information to customers. In-Store (IS) means that the media is limited to the store environment as opposed to out of store (OS) general media. Audio, Video, Cart, etc refer to the specific type of media. For example, IS audio could include the store-wide intercom system in a grocery store. IS audio could also include an audio message played in front of a particular product. IS video could include a screen that displays video images in a certain portion of a store. IS cart refers to various forms of media which may be located on a shopping cart including billboard, audio, video, smell, etc. Messages or advertisements can be broadcast by individual media or combinations of synchronized media to produce different customer responses. In addition, media can be broadcast in local stores or throughout a chain or network. The term local means that the media is only broadcast in one store which may have unique characteristics. The term chain refers to media that is broadcast in a group of stores. By identifying the metrics associated with various media combinations and permutations, it is possible to determine the optimum media combinations for particular messages and advertisements.

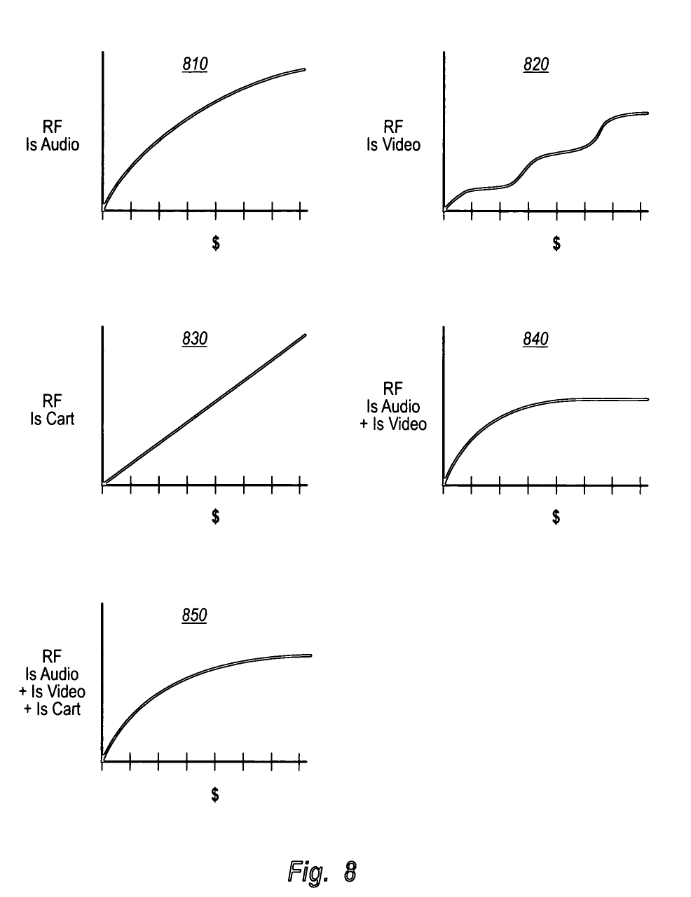

Reference is next made to FIG. 8 which illustrates a group of graphs, each showing RF curves of customer response to a particular media. It is important to note the illustrated curves do not represent actual data and are merely examples for the purpose of illustrating an embodiment of the present invention. The first curve is a Reach/Frequency (RF) curve of In-Store (IS) audio media versus money spent 810. Media messages and advertisements are often sold in blocks of gross rating points and there is an associated price per rating point. In order to simplify the graphs and enable direct comparison, the graphs utilize money spent rather than rating points purchased. The RF IS Audio curve 810 is primarily logarithmic indicating that the RF response diminishes the more money that is spent on additional rating points. Therefore, advertisers often determine an inflection point and associated inflection range throughout which it is efficient to advertise using this media.

Likewise, the other illustrated curves graph metric values for particular media or media combinations. The second curve is an RF IS Video curve versus money spent 820. The actual curve is irregularly shaped making it difficult to clearly determine how much money to spend on advertising for this form of media. The third curve is an RF IS Cart curve versus money spent 830. This curve appears linear meaning that there is an equal RF response for any amount of money spent. The fourth curve is an IS Audio+IS video curve versus money spent 840. This curve is unique in that it is analyzing the metric value for a combination of media. It appears on the curve, after a certain amount of money is spent, no additional RF response is achieved. Curve 840 therefore gives additional information over simply analyzing curves 810 and 820 individually. Likewise, the fifth curve is an RF IS Audio+IS Video+IS Cart curve versus money spent 850. In addition, the combination curves 840, 850 provide a metric for the combined media which may be significantly different than simply adding the two individual curves. For example, if an advertisement is broadcast over an IS Audio media and is also simultaneously broadcast over an IS Video media, the combined effect may be to annoy customers causing the metrics to decrease. Whereas, taken individually the IS Audio and the IS video may produce a particular result, it is not clear how customers will respond to the combination without actually analyzing the combination.

The RF value on each of the curves could be replaced with any metric value including but not limited to frequency, sales, awareness ,etc. Likewise, the media or media combination could be replaced with any media permutation contemplated by those skilled in the art. In addition, other variables could be incorporated into this analysis to produce more pertinent information for a particular advertising target group. For example, single, white, males between the ages of 20 and 40 may produce different metric values than married, asian, females over 50 years of age. It is also possible to plot multiple metric media values on a single graph to indicate the most efficient use of a particular amount of money. For example, curves 810, 820, 830, 840, and 850 could be plotted on the same graph to illustrate which of the media combinations is most effective. Various other data graphing techniques known in the art are consistent with the present invention including three dimensional graphing, color charts, etc.

Combination metrics may be obtained in various ways and remain consistent with the present invention. In a store environment these techniques generally include obtaining customer response data from customer response devices such as loyalty cards. In order to correlate the customer response information with multiple media messages particular techniques may be used including random duplication, personal probability, and other duplication methodologies. These techniques are known to those skilled in the art of numerical analysis.

Thus, as discussed herein, the embodiments of the present invention embrace systems and methods for measuring customer response and optimizing advertising. More particularly, the present invention relates to a method of acquiring advertising data and a method of optimizing advertising variable settings in response to acquired data. The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

1. A method for obtaining metric media values comprising the steps of:
broadcasting a test advertisement via at least one form of media within a restricted environment;
obtaining customer response data in response to the broadcasted test advertisement before each corresponding customer leaves the restricted environment; and
generating metric values from the customer response data for the at least one form of media.

2. The method of claim 1, wherein the at least one form of media includes any single or combination of media.

3. The method of claim 1, wherein the restricted environment is a retail store.

4. The method of claim 1, wherein the at least one form of media includes audio, video, radio, television, billboard, taste, and smell.

5. The method of claim 1, wherein the step of obtaining customer response data in response to the broadcasted test advertisement further includes obtaining customer response data from at least one customer response device.

6. The method of claim 1, wherein the step of obtaining customer response data in response to the broadcasted message further includes obtaining out-of-store customer response data from an advertiser for use in generating combination metrics of in-store media and out-of-store media.

7. The method of claim 1 further including the step of correlating the customer response data and generated metric values with particular customer information.

8. The method of claim 7, wherein the step of correlating the customer response data and generated metric values with particular customer information further includes obtaining customer information from a customer information device.

9. A method for predicting the most effective combination of media comprising the steps of:
broadcasting a plurality of test advertisements via a plurality of media permutations;
obtaining customer response data in response to the test advertisements;
generating metric values from the customer response data for the plurality of media permutations;
graphing the metric values of each media permutation in a curve illustrating the metric value versus the allocated cost for broadcasting in each media permutation.

10. The method of claim 9, wherein the plurality of media permutations includes combinations of video, audio, visual, taste, and smell.

11. The method of claim 9, wherein the plurality of media permutations includes combinations of in-store media and out-of-store media.

12. The method of claim 9, wherein the allocated cost for broadcasting in each media permutation is the cost per rating point.

13. The method of claim 9 further including identifying an inflection point on each graph to identify the most efficient metric response for a particular media permutation.

14. A method for obtaining metric in-store media values comprising the steps of:
broadcasting a test advertisement in a store environment via a plurality of media;
obtaining customer response data in response to the broadcasted test advertisement; and
generating metric values from the customer response data for the plurality of in-store media.

15. The method of claim 14, wherein the plurality of in-store media includes any combination of in-store media.

16. The method of claim 14, wherein the plurality of media includes combinations of audio, video, radio, television, billboard, taste, and smell.

17. The method of claim 14, wherein the step of obtaining customer response data in response to the broadcasted test advertisement further includes obtaining customer response data from at least one customer response device.

18. The method of claim 14 further including the step of correlating the customer response data and generated metric values with particular customer information.

19. The method of claim 18, wherein the step of correlating the customer response data and generated metric values with particular customer information further includes obtaining customer information from a customer information device.

20. The method of claim 14, wherein the step of generating metric values from the customer response data for the plurality of in-store media utilizes a process of personal probability.

21. The method of claim 14, wherein the step of generating metric values from the customer response data for the plurality of in-store media utilizes a process of random duplication.
